(19) United States
(12) Patent Application Publication
(10) Pub. No.: US 2008/0141140 A1
(43) Pub. Date: Jun. 12, 2008

(54) METHOD FOR PUBLICITY AND ACCESSING THE WORLDWIDE NETWORK BY USING SOFTWARE ALLOWING IDENTIFICATION OF A USER, NAVIGATION CONNECTION DURATION, AND RECORDED DATA FOR TRANSMISSION TO A SERVER

(75) Inventor: Denner Antonio DA SILVA, Rio de Janeiro (BR)

Correspondence Address: EGBERT LAW OFFICES, 412 MAIN STREET, 7TH FLOOR, HOUSTON, TX, 77002, US

(73) Assignees: Denner Antonio DA SILVA, Rio de Janeiro (BR); Brunswick Consultores Associados Com. E Repr. Ltda., Rio de Janeiro (BR)

(21) Appl. No.: 11/608,385

(22) Filed: Dec. 8, 2006

(51) Int. Cl. G06F 3/00

(52) U.S. Cl. 715/745; 715/749

(57) ABSTRACT

The present invention is a method for accessing the worldwide network by using software installed in each user's equipment generating a control and a proper screen, the so-called connection media. Navigating through the Internet allows the transmission of data about the duration of connection and the user's data to a service provider. In the preferred embodiment of the invention an advertiser can place their advertisement on that proper screen, the so-called connection media, and pay for the real time of exhibition, that is, for duration of each user's connection. The novelty of this invention is to allow an advertisement to be permanently exhibited and visualized irrespective of the page being visited by the user.

### CROSS-REFERENCE TO RELATED U.S. APPLICATIONS

Not Applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a method for publicity and accessing the worldwide network allowing identification of the user and his connection duration for data transmission to a server.

2. Description of Related Art Including Information Disclosed Under 37 CFR 1.97 and 37 CFR 1.98

Use of the worldwide network is increasing day after day, including the trade of goods and services. Companies need to advertise their goods and services, as is already done on television, newspaper, magazines, brochures, theaters and the like, hence the creation of proper pages. The number of pages has reached such an amount that localization thereof is now difficult which, in turn, restrains business growth.

One way found hitherto for mitigating such a problem is the development of search sites. The problem, however, is difficult to fix because every new type of filtering adopted is immediately expanded and swollen, not serving as a filter per se. Companies are still searching for a way of having their own page visited so that they can exhibit their goods and services.

The tools, available to the companies, include the use of poll agencies, identification of the user who is accessing the network through IP (Internet Protocol), the counters of the number of visits located at the pages. These tools indicate the problem but do not fix it.

Another way, developed by the big companies, was the creation of multi-application portals to keep the user's attention; however, that alternative does not prove to be effective either. In the process of consolidating the maturity of Internet user's in the country, the big portals are facing some difficulties in keeping the internaut present at their domain pages. This happens because of the dispersion of audience and the increasing offer of content provided by corporate sites (companies) and personal sites (blogs, fotoblogs etc.). This does not interfere with servers' remuneration, to the extent that the need of connection continues to be primordial, but the advertising potential is crushed to the extent that the flow of access to proprietary pages increases in a smaller and smaller rhythm.

This problem is a chronic process, to the extent that the number of advertisers believing in this media buy more and more, and annually the number of companies using the network for online advertisements rises 29% on average. Statistics shows that the number of accesses to goods and services advertisers pages increases in a smaller and smaller ratio, in proportion, relative to the increase of the number of advertisers online, evidencing how the internaut is more and more dissatisfied with those sorts of pages. An immediate consequence is that advertising online gets more expensive in the ratio cost/benefit. Keeping the share in the last 36 months becomes a hard task.

With the increase of network utilization by each user, and the methodology of acquisition by page views, there is no encouraging prospect at all. In 2002, a user, who used to generate 300 page views/month now generates almost 2,000. Now in a market adaptation process, some of the disclosing formats and patterns have already been meeting the formula for a settled exhibition for a given time (like television), in order to try to frame an option for better cost benefit.

Some data relating to raising of the media prices are:

Growth of the media raw audience (range)

| | | Metrics | |
|---|---|---|---|
| | December 2005 | December 2004 | % Change |
| Sessions/Visits per Person | 28 | 24 | 17% |
| Domains Visited per Person | 53 | 43 | 23% |
| Web Page Views per | 1,477 | 867 | 69% |
| Person | | | |
| PC Time per Person | 29:37:57 | 24:48:17 | 19% |
| Duration of a Web Page | 00:00:44 | 00:00:57 | −23% |
| viewed | | | |
| Current Digital Media | 19,955,734 | 18,660,122 | 7% |
| Universe Estimate | | | |

Nominal growth of 7% is a very superficial assessment of the Internet user behavioral evolution. Anyway, even this rate exceeds the growth of penetration of cable TV, newspapers and magazines.

Exponential dispersion of the media audience

| | | Metrics | |
|---|---|---|---|
| | December 2005 | December 2004 | % Change |
| Sessions/Visits per Person | 28 | 24 | 17% |
| Domains Visited per Person | 53 | 43 | 23% |
| Web Page Views per | 1,477 | 867 | 69% |
| Person | | | |
| PC Time per Person | 29:37:57 | 24:48:17 | 19% |
| Duration of a Web Page | 00:00:44 | 00:00:57 | −23% |
| viewed | | | |
| Current Digital Media | 19,955,734 | 18,660,122 | 7% |
| Universe Estimate | | | |

Checking the domains visited within 30 days shows that difficulty in getting to a consumer through the Internet might gradually increase, having in mind that with the internaut's maturing the number of sites used for navigation raises. This indicates that in a medium term it will be important to have the disclosure means used at media level expanded to the same performance before the target public.

Volume of Internet utilization (frequency and duration)

| | | Metrics | |
|---|---|---|---|
| | December 2005 | December 2004 | % Change |
| Sessions/Visits per Person | 28 | 24 | 17% |
| Domains Visited per Person | 53 | 43 | 23% |
| Web Page Views per | 1,477 | 867 | 69% |
| Person | | | |
| PC Time per Person | 29:37:57 | 24:48:17 | 19% |
| Duration of a Web Page | 00:00:44 | 00:00:57 | −23% |
| viewed | | | |
| Current Digital Media | 19,955,734 | 18,660,122 | 7% |
| Universe Estimate | | | |

Permanence time is a synonymous for delivery capacity the medium provides—in practice Internet is able to increase its share on the consumer's time due to an optimization of contents and new offers of entertainment. In a scale of maximum importance, the growth of page views influences directly the media costs, for it concerns the reference unit of acquiring publicity on the media (CPM IMPACT), therefore, so as to maintain the same average frequency from one year to the next it would be necessary to raise by 69% the acquisition of page views.

The paradigm of impact—the problem of time of exhibition

| | | Metrics | |
|---|---|---|---|
| | December 2005 | December 2004 | % Change |
| Sessions/Visits per Person | 28 | 24 | 17% |
| Domains Visited per Person | 53 | 43 | 23% |
| Web Page Views per | 1,477 | 867 | 69% |
| Person | | | |
| PC Time per Person | 29:37:57 | 24:48:17 | 19% |
| Duration of a Web Page | 00:00:44 | 00:00:57 | −23% |
| viewed | | | |
| Current Digital Media | 19,955,734 | 18,660,122 | 7% |
| Universe Estimate | | | |

An important aspect of checking the average time per page view is the reduction of the banner impact exhibition, or the occasional non-absorption of the advertising message due to priority with the contents the web pages. This indicates we shall value even more the privileged positions on pages, establishing as a rule the use of the “first scroll” for disclosing the pieces.

### BRIEF SUMMARY OF THE INVENTION

The present invention relates to a method for accessing the worldwide network by using software installed in each user's equipment generating a control and a proper screen, the so-called connection media, for navigating through the Internet allowing the transmission of data about the duration of connection and the user's data to a service provider. In the preferred embodiment of the invention an advertiser can place their advertisement on that proper screen, the so-called connection media, and pay for the real time of exhibition, that is, for duration of each user's connection. The novelty of this invention is to allow an advertisement to be permanently exhibited and visualized irrespective of the page being visited by the user.

### BRIEF DESCRIPTION OF THE SEVERAL VIEWS OF THE DRAWINGS

The present invention will be better understood referring to the accompanying drawings.

FIG. 1 is a schematic view of an active user terminal with installed software.

FIG. 2 is a schematic view of the method of the present invention.

FIG. 3 is a schematic view of the range of the method of operation of the present invention.

FIG. 4 is a schematic view of the method of operation, showing data exchange with a server.

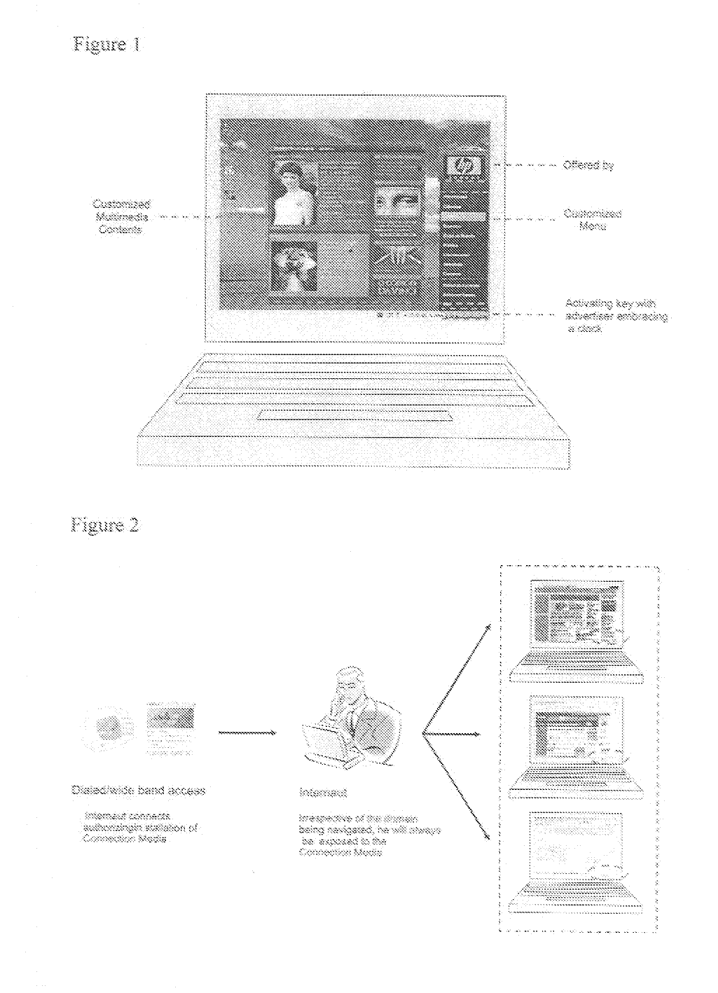

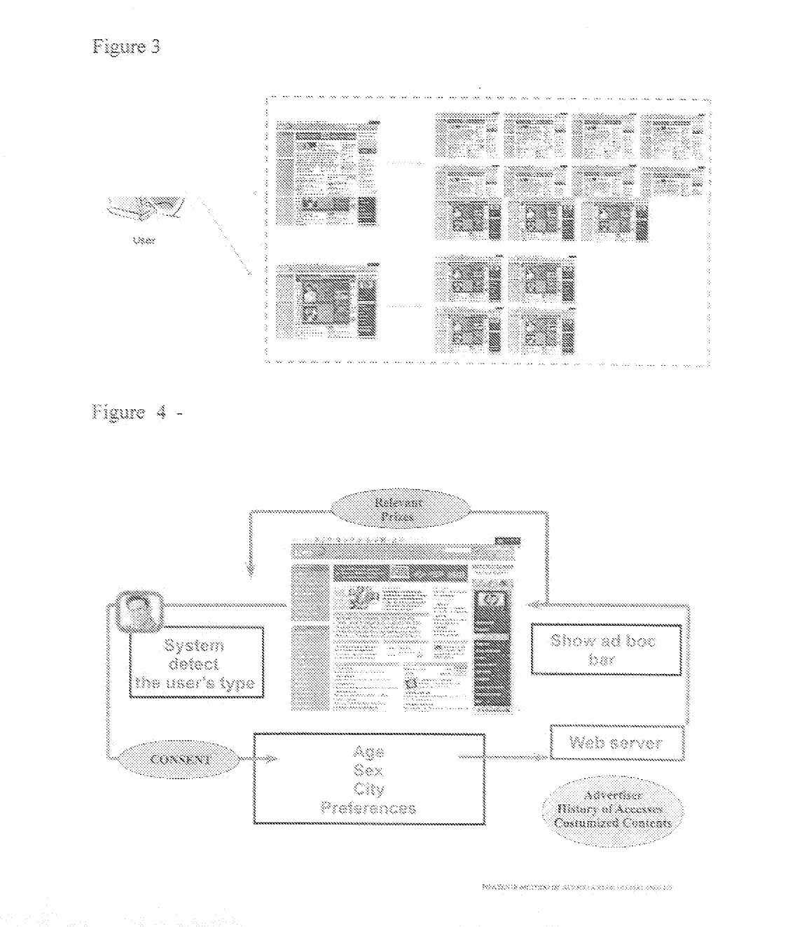

### DETAILED DESCRIPTION OF THE INVENTION

This situation has lead to pollution and exploitation of the internaut. The aggressive burst of a number of advertising formats on the portal pages is annoying the users. International research indicates a dissatisfaction number of over 75% of the internauts all over the world with the present system of online publicity. The quality of the content provided is more and more questionable. The multimedia option and interaction platforms are out-of-phase and replication of success formulas of printed and television media through the network do not fascinate portal subscribers anymore. Additional products complete the “foot shot” option stimulated by the players. Additional space for e-mail, photo-albums, virtual hard drives, online anti-virus etc. are charged extra elucidating even more the supercharge theory.

The following tripods can be shown:

a) for diagnosis

Portals

Break Event Portals spend a lot with their contents and the equation has a deficit, since the time spent in their pages by users is becoming shorter and shorter and the cost of production raises in a geometric progression. It is the portals' huge mission to convert the connection duration of users.

Advertisers
Qualification upon contact: they want segmentation, video formats and to add value to their mark.
Quantification is not made by the impact but by time of attention the consumer will dedicate to the product/mark/service.

Internauts
Manager of the process: he selects what he wants and how he wants it. Opportunity to render services and fidelization.

b) for solution

Portals

Change in assessment: now divide to multiply later (relevant prizes)

Effective customization and building loyalty co-branded with advertiser

An option which does not inhibit or upset the traditional profits with banners in page

Advertisers
Change in assessment: “less with more” instead of “more with less”
Effective customization and building of loyalty

Internauts
Delivery of perceived value
Rendering customized services
Advertising only with consent

The solution could be described as follows: The tool Connection Media consists of a service from a new commercial format, focusing on the building of a relationship between advertisers and internauts, through exploitation of tripod: rendering of services, segmentation and multimedia. Its use by server provides for delivering the perceived value to advertisers and internauts, by building a co-branded fidelization.

In summary, the method has the following advantages:

a) for users

A new commercial format not polluting the page

Perception of valor provided by the mark:
Customized contents according to the user's profile
Several relevant prizes to be won! No more than one opt-in!

A new basis of relationship with the server and advertiser is established

b) for portals

A new format with an expressive commercial potential is made available

Extension of commercial range is enabled

A new basis of relationship with the internaut and advertiser is established

Competitive differential is imparted

Appeal for extending subscribers base is provided

c) for advertisers

Migration from the standard model of direct sales appeal to delivery of value perceived by the internaut

The new format does not contribute to page pollution

A new basis of relationship with the internaut and server is established

Extension of commercial range is provided

1. A method for publicity and accessing the local network, said method comprising the steps of:
using a software;
generating a portal on equipment of a user; and
implementing control of duration of connection to a network and data transmission to a remote unit.

2. A method according to claim 1, wherein said portal allows placement of advertisements.

3. A method according to claim 1, further comprising:
transmitting connection duration data and data regarding the user to an Internet server.

4. A method according to claim 1, wherein said software identifies the user along with recorded personal and general data.

5. A method according to claim 1, further comprising:
paying servers for advertisements by real duration of connection to the network irrespective to the pages visited.
